(19) United States
(12) Patent Application Publication
(10) Pub. No.: US 2025/0089979 A1
(43) Pub. Date: Mar. 20, 2025

(54) DISHWASHER

(71) Applicant: SAMSUNG ELECTRONICS CO., LTD., Suwon-si (KR)

(72) Inventors: Johannes BÜSING, Suwon-si (KR); Jisun YANG, Suwon-si (KR)

(73) Assignee: SAMSUNG ELECTRONICS CO., LTD., Suwon-si (KR)

(21) Appl. No.: 18/962,269

(22) Filed: Nov. 27, 2024

Related U.S. Application Data
(63) Continuation of application No. PCT/KR2023/008353, filed on Jun. 16, 2023.

(30) Foreign Application Priority Data
Jun. 30, 2022 (KR) 10-2022-0080943
Aug. 24, 2022 (KR) 10-2022-0106279

(51) Int. Cl. A47L 15/42; B01D 29/03; B01D 29/31; B01D 29/56

(52) U.S. Cl. CPC A47L 15/4206; A47L 15/4204; A47L 15/4208; A47L 15/4225; B01D 29/03; B01D 29/31; B01D 29/56

(57) ABSTRACT

A dishwasher may comprise: a tub forming a washing chamber; a sump comprising a bottom portion, a side portion, a water storage chamber formed by the bottom portion and the side portion and configured to store water in the tub, and a first coupling portion formed on the side portion; and a filter coupleable to and decoupleable from the water storage chamber to filter foreign substances from the water. The filter comprises a second coupling portion which rotates to be coupled to the first coupling portion. While the second coupling portion is coupled to the first coupling portion, the second coupling portion holds the first coupling portion in place along a vertical direction of the washing chamber.

### CROSS-REFERENCE TO RELATED APPLICATION

This application is a continuation application, under 35 U.S.C. § 111(a), of international application No. PCT/KR2023/008353, filed Jun. 16, 2023, which claims priority under 35 U.S.C. § 119 to Korean Patent Application No. 10-2022-0080943, filed Jun. 30, 2022, and Korean Patent Application No. 10-2022-0106279, filed Aug. 24, 2022, the disclosures of which are incorporated herein by reference in their entireties.

### TECHNICAL FIELD

The disclosure relates to a dishwasher including an improved structure.

### BACKGROUND ART

In general, a dishwasher is an appliance that automatically washes food residues and the like from dishes using detergent and water.

The dishwasher may include a tub forming a washing cavity, a sump for collecting water into the tub, a pump for pumping water in the sump, and a sprayer for spraying the pumped water into the tub.

The dishwasher may include a filter mounted in the sump for filtering foreign substances contained in the water. Water from which foreign substances is filtered by the filter may be sprayed into the tub through the pump and the sprayer.

### DISCLOSURE

### Technical Problem

An aspect of the present disclosure is directed to a dishwasher with an improved filter structure.

An aspect of the present disclosure is directed to a dishwasher with an improved seal between a sump and a filter.

An aspect of the present disclosure is directed to a dishwasher with an improved holding force between a sump and a filter.

An aspect of the present disclosure is directed to a dishwasher capable of preventing a filter from deforming.

An aspect of the present disclosure is directed to a dishwasher in which a filter is easily assembled and/or disassembled.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a dishwasher may include a tub forming a washing chamber, a sump, and a filter. The sump may include a bottom portion, a side portion surrounding the bottom portion, a water storage chamber formed by the bottom portion and the side portion and configured to store water in the tub, and a first coupling portion formed in the side portion. The filter may be coupleable to and decoupleable from the water storage chamber to filter foreign substances from the water while the filter is coupled to the water storage chamber. The filter may include a second coupling portion coupled to the first coupling portion by rotation so that while the second coupling portion is coupled to the first coupling portion, the second coupling portion holds the first coupling portion in place along a vertical direction of the washing chamber.

The first coupling portion of the sump may include a first protrusion protruding inwardly from the side portion. The first coupling portion of the sump may include a second protrusion protruding upwardly from the first protrusion.

The second coupling portion of the filter may include an upper holding portion extending from an outer surface of the filter and configured to be caught by the second protrusion of the first coupling portion.

The upper holding portion may include a first extension extending outwardly from the outer surface of the filter to cover an upper end of the second protrusion of the first coupling portion. The upper holding portion may include a second extension extending downwardly from the first extension to cover an outer surface of the second protrusion of the first coupling portion.

The second coupling portion of the filter may include a lower holding portion extending from an outer surface of the filter and configured to be held on a lower portion of the first protrusion by rotation of the filter.

The first protrusion may be configured to press against the lower holding portion by the rotation of the filter.

The filter may be a first filter. The dishwasher may further include a second filter configured to surround an outer surface of the first filter, and a seat portion formed on the side portion to allow the second filter to be accommodated in the water storage chamber. The second filter may be configured to press against the seat portion by rotation of the first filter.

The seat portion may include a seating surface in contact with a lower surface of the second filter. The seat portion may include a first cover protrusion extending upwardly from the seating surface to cover an inner surface of the second filter. The seat portion may include a second cover protrusion extending upwardly from the seating surface to cover an outer surface of the second filter.

The filter may be a first filter. The dishwasher may include a second filter disposed in the water storage chamber and configured to surround an outer surface of the first filter. The dishwasher may include a third filter located on a lower surface of the tub and disposed on an upper side of the second filter, the third filter including an opening into which the first filter is inserted. The first filter may further include a filter flange protruding from the outer surface of the first filter so as to be supported by the third filter while being inserted into the opening.

The filter flange may be configured to press against the second filter and the third filter by rotation of the first filter.

The third filter may be configured to press against the lower surface of the tub by rotation of the first filter.

The dishwasher may further include a drain pump detachably coupled to the sump and configured to drain the water and foreign substances in the water storage chamber. The filter may further include an incision open to face the drain pump. Foreign substances filtered out by the filter may flow to the drain pump through the incision.

The first coupling portion of the sump may include a stopper interfering with the lower holding portion to limit the rotation of the filter and extending from one side of the first protrusion toward the bottom portion. The first coupling portion of the sump may include a guide portion formed by the first protrusion and the stopper to guide movement of the lower holding portion.

The lower holding portion may have a shape that slopes downward along a direction of rotation of the filter. The guide portion may have a shape corresponding to the lower holding portion.

The filter may be a first filter. The dishwasher may include a second filter disposed in the water storage chamber and configured to surround an outer surface of the first filter. The side portion of the sump may include a first side wall extending upwardly from the bottom portion and couplable with the first filter, a connecting wall extending outwardly from the first side wall and couplable with the second filter, and a second side wall extending upwardly from the connecting wall. The water storage chamber of the sump may include a first region formed between the second filter and the second side wall to allow the water filtered of foreign substances by the first filter and the second filter to flow, and a second region other than the first region, the second region in which foreign substances captured by the first filter and the second filter are accommodated.

According to an embodiment of the present disclosure, a dishwasher may include a tub, a sump including a water storage chamber configured to store water in the tub, a filter assembly disposed in the water storage chamber to filter foreign substances contained in the water. The filter assembly may include a first filter rotatably coupled to the sump, and a second filter configured to filter foreign substances contained in the water passing through the first filter and to surround the first filter. The second filter may be brought into close contact with the sump by rotation of the first filter.

The sump may include a first protrusion extending from an inner surface of the sump toward the first filter, and a second protrusion bending upwardly from the first protrusion. The first filter may include a first holding portion capable of holding to a lower portion of the first protrusion, a second holding portion spaced apart from the first holding portion to interfere with the second protrusion.

The second holding portion may include a first extension extending radially outward from the outer surface of the filter to cover an upper end of the second protrusion. The second holding portion may include a second extension extending downwardly from the first extension to cover an outer surface of the second protrusion.

The dishwasher may include a third filter placed on a lower surface of the tub and disposed on an upper side of the second filter, the third filter including an opening into which the first filter is inserted. In response to rotation of the first filter while being inserted into the opening of the third filter, the third filter may be brought into close contact with the tub.

The dishwasher may further include a support plate seated on the lower surface of the tub to support at least a portion of the third filter. The third filter may be configured to press against the support plate by rotation of the first filter.

### Advantageous Effects

According to an aspect of the present disclosure, the dishwasher may have improved washing performance.

According to an aspect of the present disclosure, the dishwasher may improve the sealing force between the sump and the filter.

According to an aspect of the present disclosure, the dishwasher may improve the holding force between the sump and the filter.

According to an aspect of the present disclosure, the dishwasher may prevent the filter from deforming.

According to an aspect of the present disclosure, the dishwasher may facilitate cleaning and/or replacement of the filter.

The effects that may be obtained from the present disclosure are not limited to those mentioned above, and other effects not mentioned will be apparent to those of skilled in the art to which the present disclosure belongs from the following description.

### DESCRIPTION OF DRAWINGS

FIG. 1 is a perspective view illustrating an example of a dishwasher, according to an embodiment.

FIG. 2 is a side cross-sectional view illustrating an example of the dishwasher, according to an embodiment.

FIG. 3 is a schematic perspective view illustrating some configurations of the dishwasher according to an embodiment.

FIG. 4 is a view illustrating a state in which a filter assembly is separated from a sump in some configurations of the dishwasher shown in FIG. 3 according to an embodiment.

FIG. 5 is a schematic perspective view illustrating some configurations of the dishwasher, according to an embodiment.

FIG. 6 is a view illustrating a state in which the filter assembly is disassembled in some configurations of the dishwasher shown in FIG. 5 according to an embodiment.

FIG. 7 is a perspective view illustrating an example of a sump housing according to an embodiment.

FIG. 8 is a perspective view of the sump housing shown in FIG. 7 from different orientation according to an embodiment.

FIG. 9 is a top view of the sump housing shown in FIG. 7 according to an embodiment.

FIG. 10 is a perspective view of the sump housing shown in FIG. 7 in a cut state according to an embodiment.

FIG. 11 is a perspective view of the sump housing shown in FIG. 7 in a cut state according to an embodiment.

FIG. 12 is a view of the sump housing shown in FIG. 11 as viewed from a cut surface according to an embodiment.

FIG. 13 is an enlarged view of a portion of the sump housing shown in FIG. 11 according to an embodiment.

FIG. 14 is a view of the portion of the sump housing shown in FIG. 13 from different orientation according to an embodiment.

FIG. 15 is a perspective view illustrating an example of a first filter according to an embodiment.

FIG. 16 is a cutaway perspective view illustrating the example of the first filter according to an embodiment.

FIG. 17 is a perspective view illustrating an example of a second filter according to an embodiment.

FIG. 18 is a perspective view illustrating an example of a third filter according to an embodiment.

FIG. 19 is a cutaway perspective view of some configurations of the dishwasher according to an embodiment.

FIG. 20 is a view of some configurations of the dishwasher shown in FIG. 19 as view from a cut surface according to an embodiment.

FIG. 21 is a cutaway perspective view of some configurations of the dishwasher shown in FIG. 19, according to an embodiment.

FIG. 22 is a view of some configurations of the dishwasher shown in FIG. 21 as viewed from a cut surface according to an embodiment.

FIG. 23 is a partial enlarged view of the dishwasher shown in FIG. 22 according to an embodiment.

FIG. 24 is a cross-sectional view illustrating the first filter in a first position, from below according to an embodiment.

FIG. 25 is a cross-sectional view illustrating the first filter in a second position, from below according to an embodiment.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

In addition, throughout the specification, when a given element is referred to as being “connected” to another element, it is to be understood that it may be connected not only directly to other elements, but also indirectly to other elements. Similarly, when a given element is referred to as being “coupled” to another element, it is to be understood that it may be coupled not only directly to other elements, but also indirectly coupled to other elements.

It will also be understood that when an element is referred to as being “on” another element, it may be directly on the other element or intervening elements may also be present.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Further, as used in the disclosure, the terms “up and down direction”, “height direction”, “vertical direction”, “horizontal direction”, “upper”, “lower”, “front-rear direction”, “radial direction”, and the like are defined with reference to the drawings, and are not intended to limit the shape and position of any element.

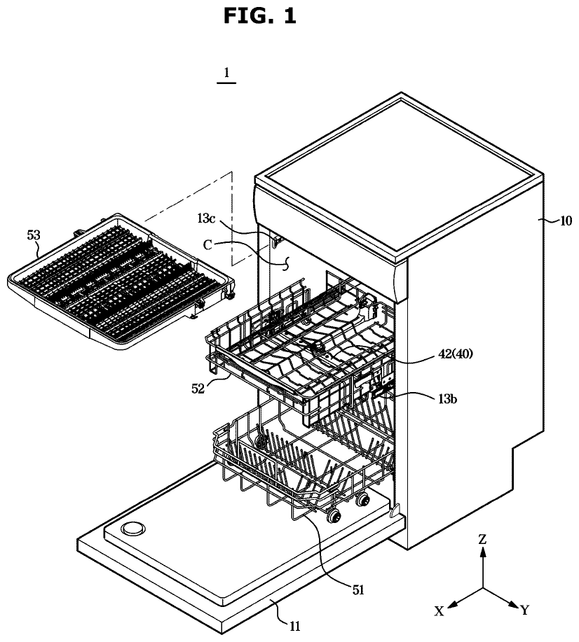

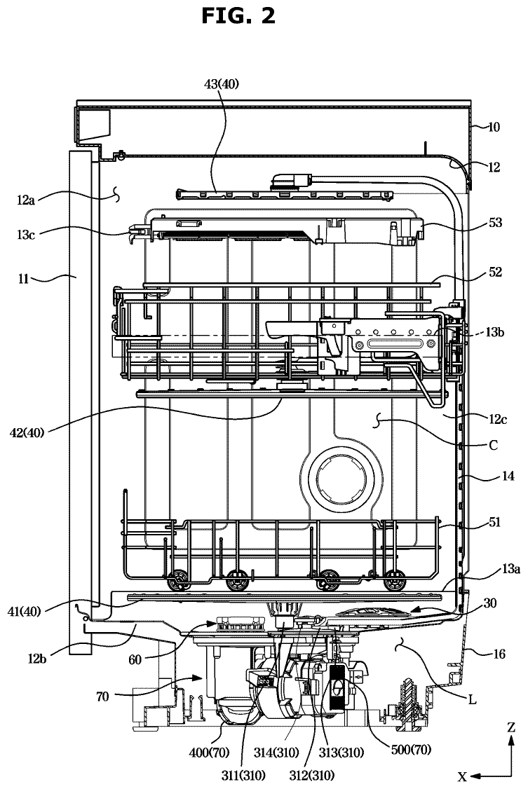

For example, referring to FIGS. 1 and 2, “up and down direction”, “height direction”, and “vertical direction” may refer to a Z direction. “horizontal direction” may refer to any direction along an X-Y plane. However, the foregoing is by way of example only and is not limited thereto.

Hereinafter, various embodiments according to the disclosure will be described in detail with reference to the accompanying drawings.

FIG. 1 is a perspective view showing an example of a dishwasher according to an embodiment. FIG. 2 is a side cross-sectional view showing an example of the dishwasher according to an embodiment.

Referring to FIGS. 1 and 2, a dishwasher 1 may include a main body 10. The main body 10 may form an exterior of the dishwasher 1.

The dishwasher 1 may include a tub 12 provided inside the main body 10. The tub 12 may be provided in an approximately box shape. One side of the tub 12 may be open. In other words, the tub 12 may have an opening 12a. In an example, the front of the tub 12 may be open.

The dishwasher 1 may include a door 11 provided to open or close the opening 12a of the tub 12. The door 11 may be installed on the main body 10 to open and close the opening 12a of the tub 12. The door 11 may be rotatably mounted to the main body 10. The door 11 may be detachably mounted to the main body 10.

The dishwasher 1 may further include a storage container provided within the tub 12 to receive dishware.

The storage container may include a plurality of baskets 51, 52 and 53. The plurality of baskets 51, 52 and 53 may be configured to hold a variety of dishware. However, the present disclosure is not limited thereto, and the storage container may include a single basket.

The storage container may include a middle basket 52 positioned at the center along the height direction of the dishwasher 1. The storage container may include a lower basket 51 positioned at a lower portion along the height direction of the dishwasher 1. The middle basket 52 may be arranged to be supported on a middle guide rack 13b. The lower basket 51 may be arranged to be supported on a lower guide rack 13a. The middle guide rack 13b may be installed on a side 12c of the tub 12 so as to be slidable toward the opening 12a of the tub 12. The lower guide rack 13a may be installed on the side 12c of the tub 12 so as to be slidable toward the opening 12a of the tub 12.

The plurality of baskets 51 and 52 may store relatively large tableware (e.g., dishes, utensils, cutlery, etc.). However, the types of tableware stored in the plurality of baskets 51 and 52 are not limited to relatively large tableware. In other words, the plurality of baskets 51 and 52 may store not only relatively large dishes but also relatively small dishes.

The storage container may include the upper basket 53 positioned at an upper portion along the height direction of the dishwasher 1. The upper basket 53 may be formed in the shape of a rack assembly, such that relatively small dishes may be stored. For example, the upper basket 53 may store cooking utensils or cutlery, such as ladles, knives, turners, and the like. The upper basket 53 may store small cups, such as espresso mugs. However, the types of tableware stored in the upper basket 53 are not limited to the above examples.

The upper basket 53 may be arranged to be supported on an upper guide rack 13c. The upper guide rack 13c may be installed on the side 12c of the tub 12. For example, the upper basket 53 may be slidably movable by the upper guide rack 13c and may be moved into or out of a washing chamber C.

The dishwasher 1 may include the washing chamber C, which is a space formed in the tub 12. The washing chamber C may be defined as an inner space of the tub 12. The washing chamber C may be a space in which tableware stored in the storage container may be washed and dried by means of water.

The dishwasher 1 may include a sprayer 40 configured to spray water. The sprayer 40 may spray water into the washing chamber C. The sprayer 40 may spray water toward tableware stored in the storage container. The sprayer 40 may receive water from a sump assembly 70 to be described later.

The sprayer 40 may include at least one spray unit. The sprayer 40 may include a single spray unit or a plurality of spray units 41, 42 and 43.

For example, the sprayer 40 may include a first spray unit 41 disposed on a lower portion of the lower basket 51 in the height direction of the dishwasher 1. The sprayer 40 may include a second spray unit 42 disposed on a lower portion of the middle basket 52 in the height direction of the dishwasher 1. The sprayer 40 may include a third spray unit 43 disposed on an upper portion of the upper basket 53 in the height direction of the dishwasher 1. However, the present disclosure is not limited thereto, and the sprayer may include two or fewer or four or more spray units.

Each of the plurality of spray units 41, 42 and 43 may be configured to spray water while rotating. The first spray unit 41, the second spray unit 42, and the third spray unit 43 may each be configured to spray water while rotating. The plurality of spray units 41, 42 and 43 may be referred to as a plurality of spray rotors 41, 42 and 43. The first spray unit 41, the second spray unit 42, and the third spray unit 43 may be referred to as a first spray rotor 41, a second spray rotor 42, and a third spray rotor 43, respectively.

However, the sprayer 40 may also spray the water in a manner different from the examples described above. For example, the first spray unit 41, unlike the second spray unit 42 and the third spray unit 43, may be fixed to one side of a lower surface 12b of the tub 12. In this case, the first spray unit 41 may be arranged to spray water in a substantially horizontal direction by a fixed nozzle, and the water sprayed in a substantially horizontal direction from the nozzle of the first spray unit 41 may be redirected to direct upwardly by a switching assembly (not shown) disposed within inside the washing chamber C. The switching assembly may be installed on a rail (not shown) and may be arranged to be translationally movable along the rail. Although the first spray unit 41 has been described as an example, the second spray unit 42 and the third spray unit 43 may also be arranged to spray water using fixed nozzles, as in the examples described above.

The dishwasher 1 may include an auxiliary sprayer 30. The auxiliary sprayer 30 may be disposed on one side of a lower portion of the washing chamber C to spray water onto a portion of the washing chamber C. The auxiliary sprayer 30 may be designed to spray water at a relatively high pressure compared to the sprayer 40, such that heavily contaminated utensils may be intensively washed. The auxiliary sprayer 30 may be referred to as an auxiliary spray unit 30. The auxiliary sprayer 30 may be arranged to spray water while rotating. The auxiliary sprayer 30 may be referred to as an auxiliary spray rotor 30.

The auxiliary sprayer 30 may be configured to as one configuration of the sprayer 40. Hereinafter, the plurality of spray units may be a concept including at least two of the first spray unit 41, the second spray unit 42, the third spray unit 43, or the auxiliary spray unit 30. Hereinafter, the plurality of spray rotors may be a concept including at least two of the first spray rotor 41, the second spray rotor 42, the third spray rotor 43, or the auxiliary spray rotor 30.

The dishwasher 1 may optionally be include the auxiliary sprayer 30. In other words, the auxiliary sprayer 30 may be omitted from the dishwasher 1.

The dishwasher 1 may include the sump assembly 70. The sump assembly 70 may be referred to as a sump 70.

The sump assembly 70 may be configured to receive water. The sump assembly 70 may collect water from the washing chamber C. For example, for smooth water collection of the sump assembly 70, the lower surface 12b of the tub 12 may be configured to slope downwardly toward the sump assembly 70. Water from the washing chamber C may flow downwardly along the slope of the lower surface 12b of the tub 12 and smoothly into the sump assembly 70.

The dishwasher 1 may include a circulation pump 500 that pumps the water stored in the sump assembly 70 to the sprayer 40. The circulation pump 500 may be configured as one configuration of the sump assembly 70. The circulation pump 500 may be disposed in a machine room L.

The dishwasher 1 may include a drain pump 400 for draining water and/or foreign substances (e.g., food waste, etc.) remaining in the sump assembly 70. The drain pump 400 may be configured as one configuration of the sump assembly 70. The drain pump 400 may be disposed in the machine room L.

Meanwhile, the sump assembly 70 may pump the collected water and provide the collected water to the sprayer 40. The sump assembly 70 may pump the collected water and provide the collected water to the auxiliary sprayer 30. The sump assembly 70 may provide the stored water to at least one of the plurality of spray units 41, 42, 43 and 30.

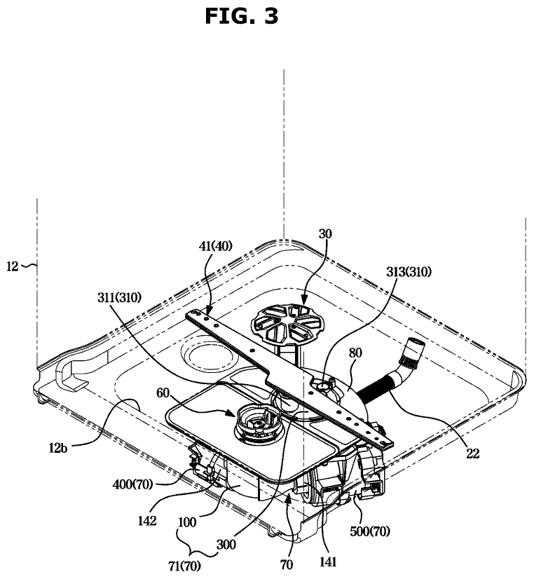

The sump assembly 70 may include a connection port 310 connected to the sprayer 40 for supplying water to the sprayer 40. For example, the connection port 310 may be connected to the sprayer 40 through a duct 14. For example, the connection port 310 may be formed in a sump cover 300 (see FIGS. 3 to 6), which will be described later.

For example, referring to FIG. 2, the connection port 310 may include a first connection port 311 connected to the first spray unit 41. The connection port 310 may include a second connection port 312 connected to the second spray unit 42. The connection port 310 may include a third connection port 313 connected to the third spray unit 43. The second connection port 312 may be connected to the second spray unit 42 by a first duct. The third connection port 313 may be connected to the third spray unit 43 by a second duct. The first duct and the second duct may be provided as separate ducts, or may be provided as the single duct 14 as shown in FIG. 2. The duct 14 may be configured to guide water from the sump assembly 70 to the sprayer 40. The duct 14 may include a shape extending in the height direction.

For example, the connection port 310 may include a fourth connection port 314 connected to the auxiliary sprayer 30. The fourth connection port 314 may be omitted depending on the presence or absence of the auxiliary sprayer 30.

The dishwasher 1 may include the machine room L, which is a space arranged below the tub 12. The machine room L may be an area in which a configuration for circulating water is arranged. The dishwasher 1 may include a base frame 16 forming the machine room L.

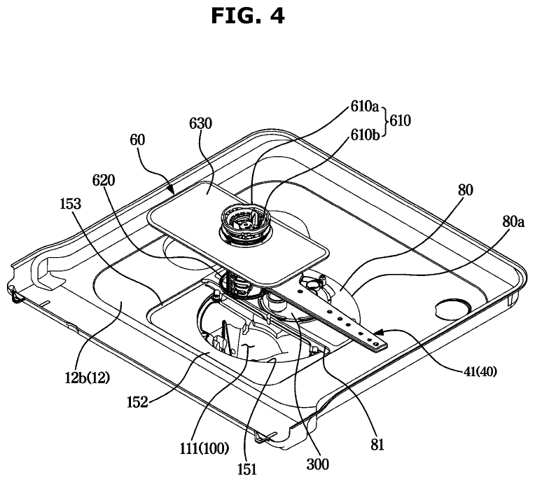

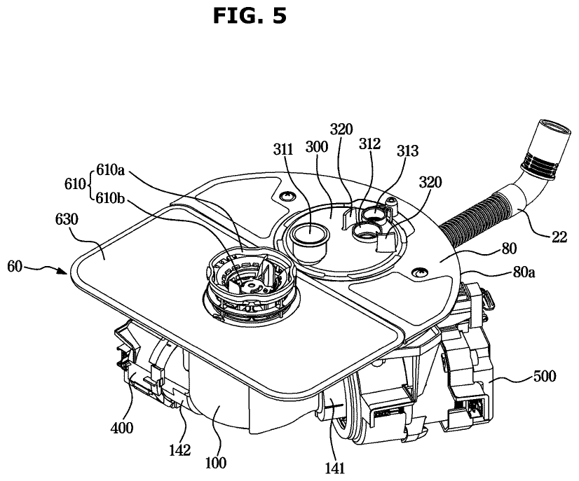

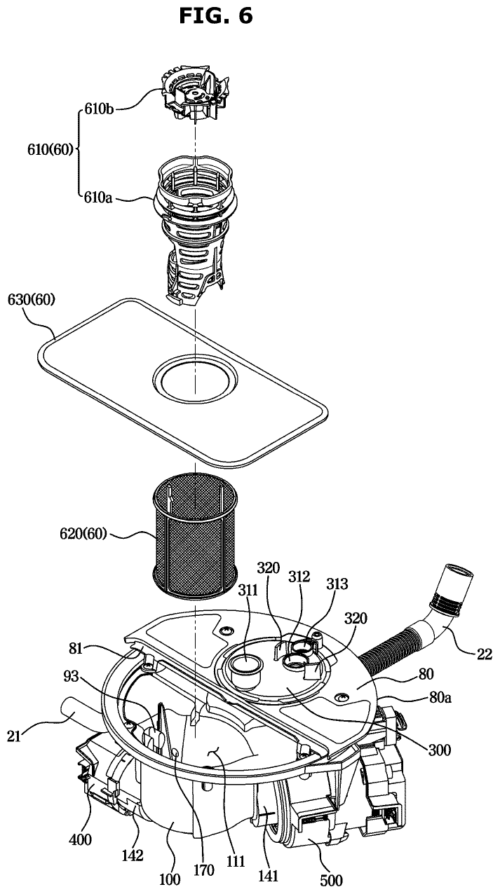

FIG. 3 is a schematic perspective view showing a partial configuration of the dishwasher according to an embodiment. FIG. 4 is a view showing a state in which a filter assembly is separated from the sump in the partial configuration of the dishwasher shown in FIG. 3. FIG. 5 is a schematic perspective view showing a partial configuration of the dishwasher according to an embodiment. FIG. 6 is a view showing a state in which the filter assembly is disassembled in the partial configuration of the dishwasher shown in FIG. 5.

Referring to FIG. 3, the dishwasher 1 may include the sump assembly 70. The sump assembly 70 may include a sump body 71. The sump body 71 may form an exterior of the sump assembly 70. The sump body 71 may be detachably provided with configurations for collecting, circulating, and supplying water.

For example, the sump body 71 may include a sump housing 100 and a sump cover 300.

The sump housing 100 may be detachably coupled to the tub 12. The sump housing 100 may be detachably coupled to the lower surface 12b of the tub 12. For example, the sump housing 100 may be screw-coupled to the lower surface 12b of the tub 12. However, the present disclosure is not limited thereto, and the sump housing 100 may be coupled to the tub 12 in a variety of ways.

The sump housing 100 may include a water storage chamber 111 (see FIGS. 4 and 6) configure to receive water. The water storage chamber 111 may be arranged to store water from the tub 12.

The sump cover 300 may be configured to cover the sump housing 100. The sump cover 300 may be arranged to cover an upper portion of the sump housing 100.

The sump cover 300 may include the connection port 310. Water stored in the sump housing 100 may be provided to the sprayer 40 through the connection port 310 of the sump cover 300.

The sump cover 300 may include a fixing portion 320. The fixing portion 320 may be arranged to secure the duct 14 and/or the auxiliary sprayer 30. The fixing portion 320 may prevent an object to be fixed from deviating. The fixing portion 320 may prevent an object to be fixed from vibrating. The fixing portion 320 may extend upwardly from an upper surface of the sump cover 300.

The dishwasher 1 may include the circulation pump 500. The sump assembly 70 may include the circulation pump 500. The circulation pump 500 may pump the water stored in the sump housing 100 and deliver the stored water to the sprayer 40. The circulation pump 500 may be detachably coupled to the sump housing 100. The circulation pump 500 may be mounted on a circulation pump connecting portion 141 of the sump housing 100. The circulation pump 500 may be arranged to be in communication with the water storage chamber 111 of the sump housing 100.

The dishwasher 1 may include the drain pump 400. The sump assembly 70 may include the drain pump 400. The drain pump 400 may be configured to drain water and foreign substances stored in the sump housing 100. The drain pump 400 may be detachably coupled to the sump housing 100. The drain pump 400 may be mounted to a drain pump connecting portion 142 of the sump housing 100. The drain pump 400 may be arranged to be in communication with the water storage chamber 111 of the sump housing 100. The drain pump 400 may be positioned lowest in the configuration of the sump assembly 70 to allow for smooth drainage.

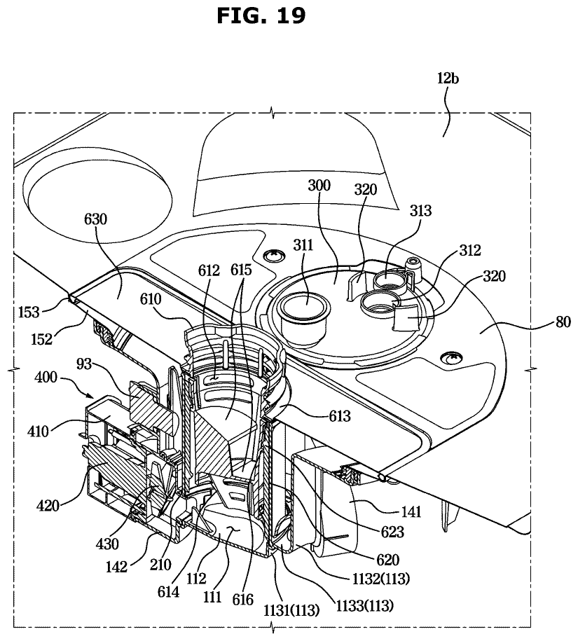

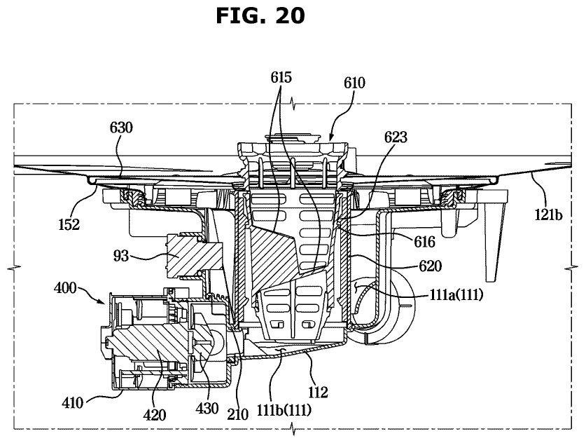

For example, the drain pump 400 may include a pump case 410 forming an exterior of the drain pump 400, a drain motor 420 accommodated in the pump case 410, and an impeller 430 connected to the drain motor 420 to be rotatable (see FIGS. 19 and 20).

The dishwasher 1 may include a support plate 80 that may be detachably mounted on the tub 12. The support plate 80 may be configured to support at least a portion of a filter assembly 60, which will be described later. For example, the support plate 80 may include a support portion 81 configured to support at least a portion of the filter assembly 60. For example, the support portion 81 may support one side of a third filter 630 of the filter assembly 60, which will be described later. For example, the support portion 81 may be arranged to form a step. The support plate 80 may be referred to as a support cover 80 or a support frame 80.

Referring to FIGS. 3 to 6, the dishwasher 1 may include the filter assembly 60. The filter assembly 60 may be provided to filter foreign substances contained in the water flowing into the sump assembly 70. The filter assembly 60 may be provided to filter foreign substances contained in the water stored in the water storage chamber 111. The water filtered through the filter assembly 60 may be pumped by the circulation pump 500 and provided to the sprayer 40. As a result, clean water from which the foreign substances have been removed may be sprayed into the washing chamber C by the sprayer 40.

The filter assembly 60 may be detachably mounted on the lower surface 12b of the tub 12. The filter assembly 60 may be detachably mounted on the sump housing 100. For example, the filter assembly 60 may be arranged to correspond to the water storage chamber 111.

The filter assembly 60 may include at least one filter. The filter assembly 60 may include one or more filters. Further details thereof will be described later.

For example, based on the filter assembly 60 including a plurality of filters, the plurality of filters may be arranged to be coupled to each other. Accordingly, the filter assembly 60 may be mounted to the tub 12 at one time or removed from the tub 12 at one time (see FIG. 4). The filter assembly 60 may be mounted to the sump housing 100 at one time or removed from the sump housing 100 at one time (see FIG. 4). This may eliminate the inconvenience of mounting or removing the filter assembly 60 as many times as the number of filters. In addition, a user may not easily lose the configuration of the filter assembly 60. As a result, the ease of use of the dishwasher may be increased.

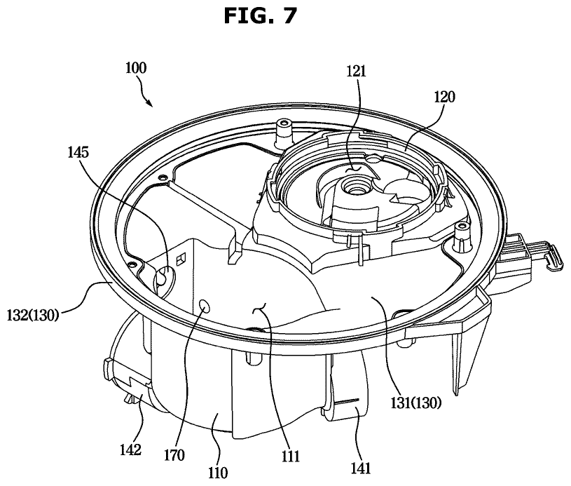

On the other hand, for example, referring to FIG. 4, the tub 12 may include a tub opening 151. The tub opening 151 may be formed on the lower surface 12b of the tub 12. For example, in a state in which the tub 12 and the sump housing 100 are coupled, the water storage chamber 111 and a distribution chamber 121 (see FIGS. 7 to 11) of the sump housing 100 may be disposed on an inner side of an edge of the tub opening 151.

The tub 12 may include a tub flange 152. The tub flange 152 may be formed on the lower surface 12b of the tub 12. For example, the tub flange 152 may be provided around the tub opening 151. For example, the tub flange 152 may form the tub opening 151.

The tub flange 152 may be provided for coupling to other configurations of the dishwasher 1. At least a portion of the sump assembly 70 may be detachably mounted to the tub flange 152. The sump housing 100 may be detachably mounted to the tub flange 152. The support plate 80 may be detachably mounted to the tub flange 152. At least a portion of the filter assembly 60 may be detachably mounted to the tub flange 152.

The tub flange 152 may be provided at a position corresponding to the sump assembly 70. The tub flange 152 may be formed at approximately a central portion of the lower surface 12b of the tub 12. However, the present disclosure is not limited thereto, and it will be appreciated that the tub flange 152 may be provided in various locations.

The tub flange 152 may include an assembly line 153. The assembly line 153 may be formed on an edge of the tub flange 152. For example, the assembly line 153 may be formed to have a step.

For example, the support plate 80 may be seated on the tub flange 152 to align with the assembly line 153. A portion 80a of the edge of the support plate 80 may be provided to correspond to the assembly line 153. This may allow the support plate 80 to be accurately mounted on the tub 12.

For example, at least a portion of the filter assembly 60 may be seated on the tub flange 152 to align with the assembly line 153. For example, one side of the third filter 630, which will be described later, may be seated on the support portion 81 of the support plate 80 placed on the tub flange 152. The other sides of the third filter 630 may be seated on the tub flange 152 to align with the assembly line 153. This may allow the filter assembly 60 to be accurately mounted on the tub 12.

Referring to FIG. 6, the filter assembly 60 may include at least one filter. In FIG. 6, the filter assembly 60 is shown as including a plurality of filters 610, 620 and 630, but is not limited thereto. The filter assembly 60 may also be configured to include only one filter.

The filter assembly 60 may include a first filter 610.

The first filter 610 may be configured to filter out relatively large size foreign substances. For example, the first filter 610 may be configured to filter out foreign substances having a size that is a larger than the size of foreign substances filtered out by a second filter 620, which will be described below. For example, the first filter 610 may be configured to filter out foreign substances having a size that is larger than the size of foreign substances filtered out by the third filter 630, which will be described below. For example, the first filter 610 may be a coarse filter.

The first filter 610 may be disposed in the water storage chamber 111 of the sump housing 100. At least a portion of the first filter 610 may be disposed in the water storage chamber 111. At least a portion of the first filter 610 may be accommodated in the water storage chamber 111. The first filter 610 may be detachably coupled to the water storage chamber 111.

The first filter 610 may be rotatably coupled to the sump housing 100. For example, the first filter 610 may be held to the sump housing 100 as it rotates. For example, by rotating of the first filter 610, a second coupling portion 800 of the first filter 610, which will be described later, may be coupled to a first coupling portion 700 of the sump housing 100, which will be described later. Further details thereof will be described later.

The first filter 610 may be provided as a single configuration. Alternatively, the first filter 610 may be provided as a plurality of configurations. For example, the first filter 610 may include a 1a filter 610a and a 1b filter 610b. The 1b filter 610b may be mounted on an upper portion of the 1a filter 610a. The 1b filter 610b may be seated on an inside of the 1a filter 610a. The 1a filter 610a and the 1b filter 610b may be detachably coupled to each other. The 1a filter 610a and the 1b filter 610b may be integrally formed. In the following, for ease of description, a case in which the first filter 610 is configured as the 1a filter 610a will be described as an example. In this case, the 1a filter 610a may be referred to as the first filter 610.

The filter assembly 60 may include the second filter 620.

The second filter 620 may be configured to filter out foreign substances having a relatively small size. For example, the second filter 620 may be configured to filter out foreign substances having a size smaller than that of foreign substances filtered out by the first filter 610. For example, the second filter 620 may be configured to filter out foreign substances having a size smaller than that of foreign substances filtered out by the third filter 630, which will be described later. For example, the second filter may be a micro filter.

The second filter 620 may be arranged to filter foreign substances contained in the water passing through the first filter 610. The second filter 620 may be arranged to filter foreign substances contained in the water passing through the third filter 630. The water that has passed through the second filter 620 may be pumped by the circulation pump 500 to flow to the sprayer 40.

The second filter 620 may be arranged in the water storage chamber 111 of the sump housing 100. At least a portion of the second filter 620 may be disposed in the water storage chamber 111. At least a portion of the second filter 620 may be accommodated in the water storage chamber 111. The second filter 620 may be detachably coupled to the water storage chamber 111.

The second filter 620 may be detachably coupled to the first filter 610. The second filter 620 may be arranged to surround the first filter 610. The second filter 620 may be arranged to surround an outer surface of the first filter 610. The second filter 620 may be arranged to cover at least a portion of the outer surface of the first filter 610. The second filter 620 may be arranged to surround a lower portion of the first filter 610. For example, the second filter 620 may be arranged in a substantially hollow cylindrical shape.

The filter assembly 60 may include the third filter 630.

The third filter 630 may be configured to filter out foreign substances having a relatively smaller size than the first filter 610. For example, the third filter 630 may be configured to filter out foreign substances having a smaller size than the foreign substances filtered out by the first filter 610. The third filter 630 may be configured to filter out foreign substances having a relatively larger size than the second filter 620. For example, the third filter 630 may be arranged to filter foreign substances having a larger size than the foreign substances filtered by the second filter 620. Although not shown in the drawings, for example, the third filter 630 may include a plurality of holes (not shown) and/or grilles (not shown) for filtering foreign substances. For example, the third filter may be a fine filter.

The third filter 630 may be detachably mounted on the lower surface 12b of the tub 12. The third filter 630 may be placed on the lower surface 12b of the tub 12. The third filter 630 may be placed on the tub flange 152 of the tub 12.

The third filter 630 may be detachably mounted to the support plate 80. At least a portion of the third filter 630 may be placed on the support plate 80.

At least a portion of the third filter 630 may be supported by the tub flange 152. At least a portion of the third filter 630 may be supported by the support plate 80. For example, one side of the third filter 630 may be seated on the support portion 81 of the support plate 80. The remaining sides of the third filter 630, except for the one side seated on the support portion 81, may be seated on the tub flange 152 to fit the assembly line 153. In the drawings, one side of the four sides of the third filter 630 is seated on the support portion 81 and the remaining three sides are seated on the tub flange 152, but the present disclosure is not limited thereto.

The first filter 610 may be inserted into the third filter 630. The third filter 630 may be positioned above the second filter 620. For example, a lower surface of the third filter 630 may be contact an upper portion of the second filter 620.

For example, the third filter 630 may include a substantially horizontal plate shape. However, the present disclosure is not limited thereto, and the shape of the third filter 630 is not limited as long as the third filter 630 is disposed in the tub 12 and is capable of filtering foreign substances contained in the water.

Hereinafter, the term “filter” may collectively refer to a member for filtering foreign substances in the water flowing through the dishwasher 1 as one configuration of the filter assembly 60. For example, the term “filter” may be a concept including at least one of the first filter 610, the second filter 620, or the third filter 630. However, the present disclosure is not limited thereto, and the “filter” may include additional configurations that may be provided as one configuration of the filter assembly 60, in addition to the first filter 610, the second filter 620, and the third filter 630.

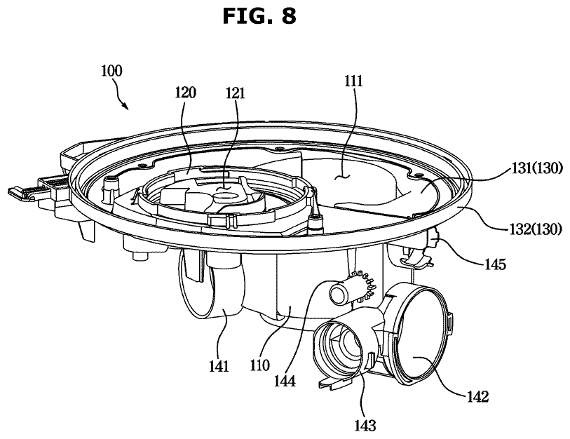

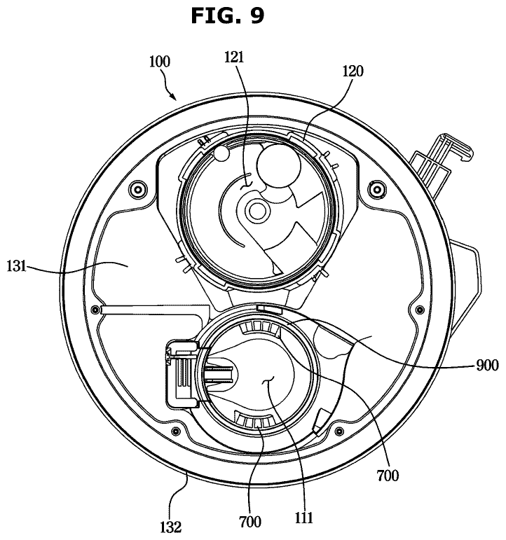

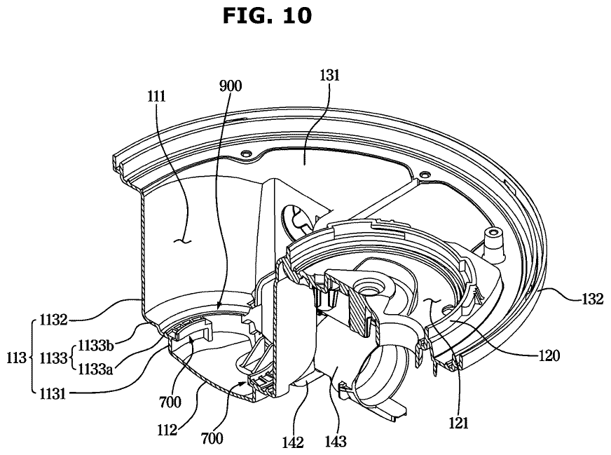

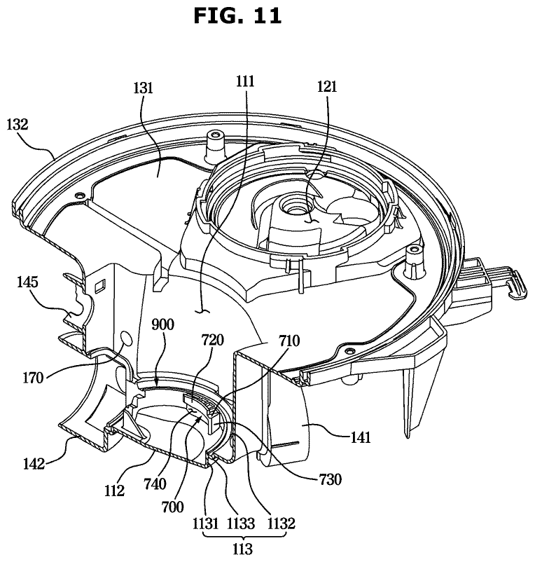

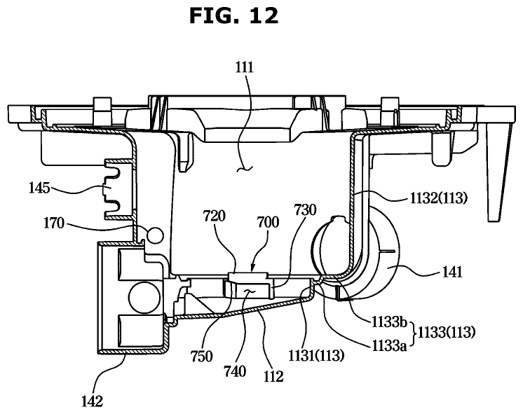

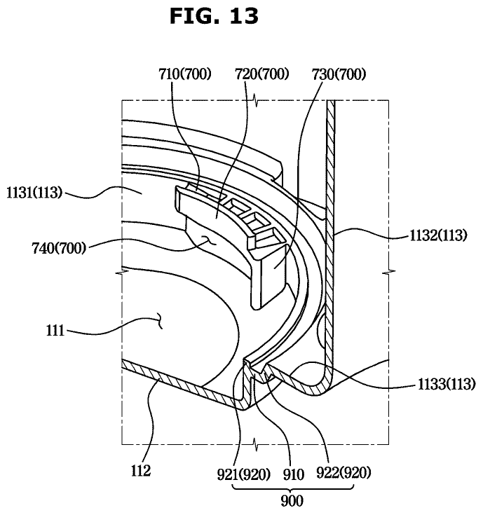

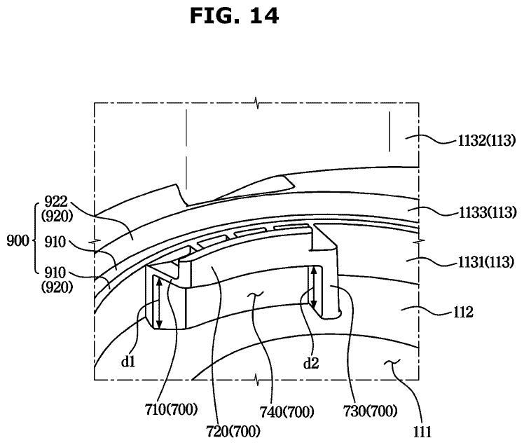

FIG. 7 is a perspective view showing an example of the sump housing. FIG. 8 is a perspective view of the sump housing shown in FIG. 7 from another direction. FIG. 9 is a top view of the sump housing shown in FIG. 7. FIG. 10 is a perspective view of the sump housing shown in FIG. 7 in a cut state. FIG. 11 is a perspective view of the sump housing shown in FIG. 7 in a cut state. FIG. 12 is a view of the sump housing shown in FIG. 11 as viewed from a cut surface. FIG. 13 is an enlarged view of a portion of the sump housing shown in FIG. 11. FIG. 14 is a view of the portion of the sump housing shown in FIG. 13 as viewed from another direction.

The sump housing 100 may be configured to receive water.

The sump housing 100 may include the water storage chamber 111 arranged to store water. The water storage chamber 111 may have an open top shape. The water storage chamber 111 may have a recessed shape. The water storage chamber 111 may receive water flowing in from a water supply pipe 21 (see FIG. 5). The water storage chamber 111 may be arranged to receive water flowing in from the tub 12.

The sump housing 100 may include the distribution chamber 121 that receives the water provided to the sprayer 40. The distribution chamber 121 may be partitioned from the water storage chamber 111. The distribution chamber 121 may receive the water stored in the water storage chamber 111.

For example, the water received in the distribution chamber 121 may be distributed to the sprayer 40 via a distributor (not shown). The distributor (not shown) may be configured to selectively supply water to the plurality of spray units. The distributor (not shown) may be configured as one configuration of the sump assembly 70. For example, at least a portion of the distributor (not shown) may be disposed within the distribution chamber 121. However, the present disclosure is not limited thereto, and the distributor (not shown) may be provided as a separate configuration from the sump assembly 70.

For example, the sump housing 100 may include a first sump body 110 provided to form the water storage chamber 111. For example, the sump housing 100 may include a second sump body 120 provided to form the distribution chamber 121.

In the drawings, the first sump body 110 and the second sump body 120 are shown as being integrally formed, but are not limited thereto. For example, the first sump body 110 and the second sump body 120 may be provided as separate configurations. In this case, the water storage chamber 111 and the distribution chamber 121 may also be provided as separate configurations.

For example, the sump housing 100 may include a third sump body 130. The third sump body 130 may refer to an exterior of the sump housing 100 other than the first sump body 110 and the second sump body 120.

For example, the third sump body 130 may include a base portion 131 connecting the first sump body 110 and the second sump body 120. For example, the third sump body 130 may include a border portion 132 protruding upwardly from an outer edge of the base portion 131.

The sump housing 100 may include the circulation pump connecting portion 141 to which the circulation pump 500 is connected. The circulation pump connecting portion 141 may be in communication with the water storage chamber 111. The water stored in the water storage chamber 111 may be introduced into the circulation pump 500 via the circulation pump connecting portion 141. For example, the circulation pump connecting portion 141 may be formed in the first sump body 110.

The sump housing 100 may include the drain pump connecting portion 142 to which a drain pump 400 is connected. The drain pump connecting portion 142 may be communicated with the water storage chamber 111. Water and foreign substances remaining in the water storage chamber 111 may be introduced into the drain pump 400 through the drain pump connecting portion 142. For example, the drain pump connecting portion 142 may be formed in the first sump body 110.

The sump housing 100 may include a drain pipe connecting portion 143 to which a drain pipe 22 (see FIG. 5) is connected. The drain pipe connecting portion 143 may be provided to be in communication with the drain pump connecting portion 142. For example, water and foreign substances contained in the water storage chamber 111 may be introduced into the drain pipe 22 via the drain pump connecting portion 142 and the drain pipe connecting portion 143 by the pumping force of the drain pump 400. The water and foreign substances introduced into the drain pipe 22 may be discharged to an outside of the dishwasher 1. For example, the drain pipe connecting portion 143 may be formed in the first sump body 110.

The sump housing 100 may include a water supply port 144 to which the water supply pipe 21 is connected. The water supply port 144 may be in communication with the water storage chamber 111. For example, the water supply port 144 may be in communication with a water supply hole 170 formed in the water storage chamber 111. For example, the water supply port 144 may be formed in the first sump body 110.

The sump housing 100 may include an auxiliary port 145. For example, a turbidity sensor 93 (see FIG. 6) may be detachably mounted in the auxiliary port 145. The turbidity sensor 93 may be configured to detect a level of contamination of the water contained in the water storage chamber 111. The controller (not shown) of the dishwasher 1 may control washing operation (or rinsing operations) of the dishwashing cycle based on the information detected by the turbidity sensor 93. For example, the auxiliary port 145 may be formed in the first sump body 110.

The sump housing 100 may include a bottom portion 112. The bottom portion 112 may include a bottom surface of the sump housing 100. Foreign substances filtered by the filter assembly 60 may accumulate in the bottom portion 112. Foreign substances remaining in the bottom portion 112 may be discharged to the outside via the drain pump 400. For example, the bottom portion 112 may include a shape that slopes downward toward the drain pump 400 to allow the water and foreign substances to be discharged smoothly. For example, the bottom portion 112 may be provided as one configuration of the first sump body 110.

The sump housing 100 may include a side portion 113. The side portion 113 may be arranged to surround the bottom portion 112. The side portion 113 may be formed on an edge of the bottom portion 112. The side portion 113 may extend upwardly from the bottom portion 112. For example, the side portion 113 may be provided as one configuration of the first sump body 110.

For example, the side portion 113 may include a first side wall 1131. The first side wall 1131 may extend upwardly from the bottom portion 112. The first side wall 1131 may have a shape extending in a substantially vertical direction.

For example, the side portion 113 may include a second side wall 1132. The second side wall 1132 may be provided on an outer side of the first side wall 1131. The second side wall 1132 may be provided on a radially outer side of the first side wall 1131. The second side wall 1132 may be positioned above the first side wall 1131. The second side wall 1132 may be connected to the third sump body 130. The second side wall 1132 may extend to the base portion 131 of the third sump body 130. The second side wall 1132 may extend upwardly from a connecting wall 1133, which will be described later. The second side wall 1132 may have a shape extending in the substantially vertical direction.

For example, the side portion 113 may include the connecting wall 1133 connecting the first side wall 1131 and the second side wall 1132. The connecting wall 1133 may extend outwardly from the first side wall 1131. The connecting wall 1133 may extend radially outward from the first side wall 1131. The connecting wall 1133 may extend in a substantially horizontal direction between the first side wall 1131 and the second side wall 1132. The connecting wall 1133 may have a shape extending along a circumferential direction of the water storage chamber 111.

For example, the connecting wall 1133 may include a first connecting wall 1133a. For example, the connecting wall 1133 may include a second connecting wall 1133b. The first connecting wall 1133a and the second connecting wall 1133b may form a step. The second connecting wall 1133b may be positioned above the first connecting wall 1133a. The first connecting wall 1133a may be formed between the first side wall 1131 and the second connecting wall 1133b. The first connecting wall 1133a may extend radially outward from the first side wall 1133a. The second connecting wall 1133b may be formed between the first connecting wall 1133a and the second side wall 1132. The second connecting wall 1133b may extend radially outward from the first connecting wall 1133a. However, this is only an example, and the shape of the connecting wall 1133 is not limited as long as it is capable of connecting the first side wall 1131 and the second side wall 1132.

The water storage chamber 111 may be formed by the bottom portion 112 and the side portion 113. The water storage chamber 111 may be defined by the bottom portion 112 and the side portion 113. For example, the bottom portion 112 may form a bottom surface of the water storage chamber 111, and the side portion 113 may form a side surface of the water storage chamber 111.

Referring to FIGS. 9 to 14, the sump housing 100 may include the first coupling portion 700.

The filter assembly 60 may be detachably mounted to the first coupling portion 700. The filter may be detachably mounted to the first coupling portion 700. For example, the first filter 610 may be detachably coupled to the first coupling portion 700. The first filter 610 may be rotatably coupled to the first coupling portion 700. The first filter 610 may be held to the first coupling portion 700 when the first filter 610 is rotated. Rotation of the first filter 610 may couple together the first coupling portion 700 of the sump housing 100 and the second coupling portion 800 of the first filter 610, which will be described later.

The first coupling portion 700 may be referred to as the first filter mounting portion 700.

The first coupling portion 700 may include a first protrusion 710 that protrudes inwardly from the side portion 113. For example, the first protrusion 710 may extend radially inward from the first side wall 1131. The first protrusion 710 may have a shape extending in the substantially horizontal direction. The first protrusion 710 may have a shape extending along the circumferential direction of the water storage chamber 111. The first protrusion 710 may extend along the circumferential direction of the water storage chamber 111 for a predetermined length. The first protrusion 710 may be formed to be spaced upwardly from the bottom portion 112.

The first protrusion 710 may be referred to as the first protrusion rib 710.

The first coupling portion 700 may include a second protrusion 720 protruding upwardly from the first protrusion 710. For example, the second protrusion 720 may be bent upwardly from the first protrusion 710. For example, the second protrusion 720 may extend upwardly from an end facing inwardly of the first protrusion 710. The second protrusion 720 may have a shape extending in the substantially vertical direction. The second protrusion 720 may have a shape extending along the circumferential direction of the water storage chamber 111. The second protrusion 720 may extend along the circumferential direction of the water storage chamber 111 for a predetermined length.

The second protrusion 720 may be referred to as the second protrusion rib 720.

For example, the first protrusion 710 and the second protrusion 720 may be arranged to be L-shape.

The first coupling portion 700 may include a stopper 730 configured to limit rotation of the filter of the filter assembly 60. For example, the stopper 730 may be arranged to limit rotation of the first filter 610. Rotation of the first filter 610 may be limited by interference with the stopper 730. For example, the stopper 730 may interfere with the second coupling portion 800 of the first filter 610, which will be described later. For example, the stopper 730 may come into contact with a lower holding portion 820 of the second coupling portion 800, which will be described later. The stopper 730 may extend from one side of the first protrusion 710 toward the bottom portion 112. The stopper 730 may extend in the substantially vertical direction.

The first coupling portion 700 may include a guide portion 740 configured to guide rotation of the first filter 610. The guide portion 740 may guide rotation of the second coupling portion 800 of the first filter 610, which will be described later. The guide portion 740 may guide movement of the lower holding portion 820 of the second coupling portion 800, which will be described later. For example, in response to rotation of the lower holding portion 820 along the guide portion 740, the first filter 610 may be held to the sump housing 100.

The guide portion 740 may be formed by the first protrusion 710 and the stopper 730. For example, the guide portion 740 may be a space surrounded by the first protrusion 710 and the stopper 730. The guide portion 740 may have a shape extending along the circumferential direction of the water storage chamber 111.

A first side of the guide portion 740 may be open. The first side may be a side away from the stopper 730. The lower holding portion 820 of the second coupling portion 800 may enter the guide portion 740 through the open first side of the guide portion 740. A second side of the guide portion 740 may be covered by the stopper 730. The second side may be a side adjacent to the stopper 730. The lower holding portion 820 of the second coupling portion 800 may rotate from the first side of the guide portion 740 toward the second side of the guide portion 740.

For example, the size of the first side of the guide portion 740 may be larger than the size of the second side of the guide portion 740. For example, a height d1 of the first side of the guide portion 740 may be greater than a height d2 of the second side of the guide portion 740 (see FIG. 14). Here, the “height” may refer to a distance from the bottom portion 112 to the first protrusion 710. For example, the first side of the guide portion 740 may be positioned higher than the second side of the guide portion 740. In other words, the bottom portion 112 corresponding to the first side of the guide portion 740 may be positioned higher than the bottom portion 112 corresponding to the second side of the guide portion 740. In response to rotation of the lower holding portion 820 of the second coupling portion 800 from the first side of the guide portion 740 to the second side of the guide portion 740, the lower holding portion 820 may move downwardly. With the structure described above, as the lower holding portion 820 of the second coupling portion 800 rotates along the guide portion 740 of the first coupling portion 700, the holding force between the first coupling portion 700 and the first filter 610 may increase. As the lower holding portion 820 of the second coupling portion 800 rotates along the guide portion 740 of the first coupling portion 700, the holding force between the first coupling portion 700 and the first filter 610 may increase.

The guide portion 740 may have a shape corresponding to the second coupling portion 800 of the first filter 610. The guide portion 740 may have a shape corresponding to the lower holding portion 820 of the second coupling portion 800. For example, the first coupling portion 700 may include an inclined portion 750. The lower holding portion 820 of the second coupling portion 800 may rotate smoothly along the inclined portion 750.

The guide portion 740 may be referred to as the guide rail 740. The guide portion 740 may be referred to as the guide groove 740.

The first coupling portion 700 may be provided in at least one. In FIG. 9, the first coupling portion 700 is shown as being two, but is not limited thereto. The first coupling portion 700 may be provided in one or three or more. The plurality of first coupling portions 700 may be arranged to be spaced apart from each other. The plurality of first coupling portions 700 may each be arranged along the circumferential direction of the water storage chamber 111.

In related art, for example, the sump housing may include a rib protruding upwardly from the bottom surface to secure an inner surface of the filter. For example, the rib may extend along the circumferential direction of the bottom surface, and a narrow gap may be formed between the side portion of the sump housing and the rib. Such a structure may be difficult to manufacture the sump housing. For example, a turning slider may be required to take the sump housing out of the mold. The use of a turning slider may require advanced technology and may complicate the process. In addition, the structure of the turning slider may cause a step or burr to form on the bottom of the sump housing during manufacturing. Such steps or burrs may easily cause water leakage. In addition, the ribs formed on the bottom of the sump housing may occupy a certain area of the bottom portion. This may reduce the volume of the sump housing to accommodate foreign substances. In addition, when foreign substances are trapped between the side portion of the sump housing and the ribs, it is not easy to clean the foreign substances.

In contrast, according to the present disclosure, the first coupling portion 700 may be formed on the side portion 113. For example, the first coupling portion 700 may be open toward an inner side thereof. The first coupling portion 700 may be spaced apart from the bottom portion 112 to form a given space (e.g., the guide portion 740). Accordingly, the sump housing 100 may be provided with a simpler geometry. In other words, the sump housing 100 may be easily manufactured because it may be removed without the need for advanced technology (e.g., a turning slider). In addition, no separate ribs are not formed on the bottom portion 112, and a given space may be ensured below the first protrusion 710. This may maximize the space capable of accommodating foreign substances in the sump housing. In addition, the first coupling portion 700 may have an inwardly open shape, so that foreign substances may be easily cleaned.

Referring to FIGS. 9 to 14, the sump housing 100 may include a seat portion 900.

The filter of the filter assembly 60 may be detachably mounted to the seat portion 900. For example, the second filter 620 may be detachably coupled to the seat portion 900. The second filter 620 may be seated on the seat portion 900. A lower portion of the second filter 620 may rest on the seat portion 900.

The second filter 620 may be arranged to press against the seat portion 900 by rotation of the first filter 610. In response to rotation of the first filter 610, the sealing force between the second filter 620 and the seat portion 900 may be improved. This will be described in more detail later.

The seat portion 900 may be provided on the side portion 113 of the sump housing 100 to allow the second filter 620 to be disposed in the water storage chamber 111. The seat portion 900 may be formed on the side portion 113 of the sump housing 100 to allow the second filter 620 to be accommodated in the water storage chamber 111.

For example, the seat portion 900 may be provided on a radially outer side of the first coupling portion 700. For example, the seat portion 900 may be arranged to support the lower portion of the second filter 620. For example, the seat portion 900 may have a shape extending along the circumferential direction of the water storage chamber 111. For example, the seat portion 900 may include a ring shape. The seat portion 900 may include a continuous ring shape. However, the present disclosure is not limited thereto, and the seat portion 900 may also include a discontinuous ring shape.

The seat portion 900 may be referred to as the second filter seat portion 900.

The seat portion 900 may have a shape corresponding to the lower portion of the second filter 620.

The seat portion 900 may include a seating surface 910 arranged to contact a lower surface of the second filter 620. The seating surface 910 may be arranged to support the lower surface of the second filter 620. For example, the seating surface 910 may be formed on the connecting wall 1133.

The seat portion 900 may include a cover protrusion 920 extending from the seating surface 910 and configured to cover the second filter 620. The cover protrusion 920 may protrude upwardly from the seating surface 910 to cover at least one of an inner surface of the second filter 620 or an outer surface of the second filter 620.

For example, the cover protrusion 920 may include a first cover protrusion 921 extending upwardly from the seating surface 910 to cover the inner surface of the second filter 620. For example, the first cover protrusion 921 may be formed on the first side wall 1131. However, the present disclosure is not limited thereto, and the first cover protrusion 921 may be formed on the connecting wall 1133.

For example, the cover protrusion 920 may include a second cover protrusion 922 extending upwardly from the seating surface 910 to cover the outer surface of the second filter 620. For example, the second cover protrusion 922 may be formed on the connecting wall 1133.

For example, the sump housing 100 may be provided to form the seat portion 900 together with a cover 210 (see FIG. 19) coupled to the sump housing 100. The cover 210 may be configured to guide water and/or foreign substances in the water storage chamber 111 to the drain pump 400. For example, the cover 210 may be detachably mounted to the water storage chamber 111 to allow access from the water storage chamber 111 to the drain pump 400. However, the present disclosure is not limited to the example described above, and the cover 210 may be provided as one configuration of the sump housing 100. The cover 210 may be integrally formed with the sump housing 100.

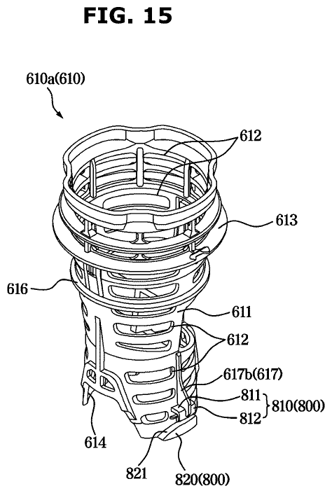

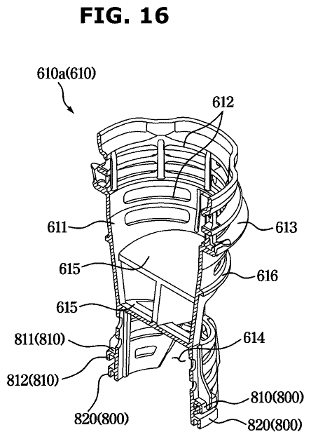

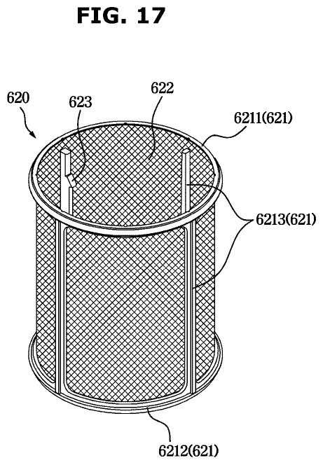

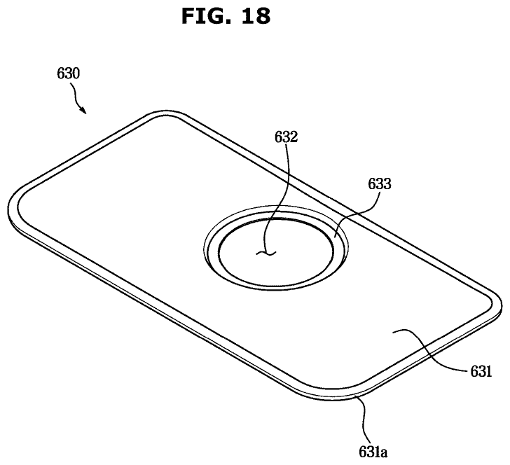

FIG. 15 is a perspective view showing an example of the first filter. FIG. 16 is a cutaway perspective view showing the example of the first filter. FIG. 17 is a perspective view showing an example of the second filter. FIG. 18 is a perspective view showing an example of the third filter.

Referring to FIGS. 15 and 16, the first filter 610 may include a filter body 611. The filter body 611 may form an exterior of the first filter 610. The filter body 611 may have a shape with an open upper portion and a lower portion. The filter body 611 may be arranged to be disposed in the water storage chamber 111.

The first filter 610 may include a plurality of holes 612 formed through the filter body 611. Foreign substances contained in the water may be filtered out by the plurality of holes 612. The plurality of holes 612 may have a variety of shapes as long as they are capable of filtering foreign substances contained in the water.

The first filter 610 may include a filter flange 613. The filter flange 613 may protrude from an outer surface of the filter body 611. The filter flange 613 may protrude radially outward from the outer surface of the filter body 611. The filter flange 613 may have a shape that extends along the perimeter of the filter body 611.

In a state in which the first filter 610 is inserted into a filter opening 632 of the third filter 630, which will be described later, the filter flange 613 may be supported by the third filter 630. For example, the filter flange 613 may be supported by a stepped portion 633 of the third filter 630, which will be described later.

The filter flange 613 may be configured to apply a force to the third filter 630. For example, as the first filter 610 is rotated while being inserted into the third filter 630, the filter flange 613 may be arranged to press against the third filter 630. The filter flange 613 may be configured to apply a force to the second filter 620. For example, as the first filter 610 is rotated while being coupled with the second filter 620, the filter flange 613 may be arranged to press against the second filter 620. This will be described in more detail later.

The first filter 610 may include an incision 614. The incision 614 may be formed by cutting a portion of the filter body 611 to face the drain pump 400. The incision 614 may be open toward the drain pump 400. Foreign substances filtered by the first filter 610 may flow through the incision 614 to the drain pump 400. Water and foreign substances may flow smoothly toward the drain pump 400 without being obstructed by the filter body 611. In other words, the incision 614 may reduce the flow loss of the water toward the drain pump 400. Such a structure may cause the flow rate of water toward the drain pump 400 to be increased and the drainage performance of the dishwasher to be improved.

The first filter 610 may include an inclined plate 615. The inclined plate 615 may be disposed within the filter body 611. The inclined plate 615 may be arranged to be inclined downward. Water and foreign substances may fall downwardly along the inclined plate 615.

The first filter 610 may include a first catch 616. The first catch 616 of the first filter 610 may be arranged to catch the second filter 620. The first catch 616 may be arranged to be caught on a second catch 623 of the second filter 620, which will be described later. The first catch 616 and the second catch 623 may interfere with each other, such that the first filter 610 and the second filter 620 may be coupled. For example, the first catch 616 may protrude from the outer surface of the filter body 611 toward the inner surface of the second filter 620. For example, the first catch 616 may have a shape that extends along the perimeter of the first filter 610. The first catch 616 may extend along the circumferential direction of the first filter 610.

The first filter 610 may include a reinforcing rib 617 for increasing the strength of the first filter 610. For example, the reinforcing rib 617 may include a first reinforcing rib 617a provided on the inner surface of the filter body 611. The first reinforcing rib 617a may have a shape extending in the vertical direction. For example, the reinforcing rib 617 may include a second reinforcing rib 617b provided on the outer surface of the filter body 611. The second reinforcing rib 617b may have a shape extending in the vertical direction.

The first filter 610 may include the second coupling member 800. The second coupling member 800 may be rotatably coupled to the first coupling portion 700 of the sump housing 100. The second coupling member 800 may be arranged to hold the first coupling portion 700 up and down. The second coupling member 800 may be arranged to be coupled to an upper portion of the first coupling portion 700 and a lower portion of the first coupling portion 700.

The second coupling member 800 may include an upper holding portion 810. The upper holding portion 810 may be arranged to hold an upper portion of the second coupling portion 700.

The upper holding portion 810 may extend from the outer surface of the first filter 610 and may be coupled to the first coupling portion 700. The upper holding portion 810 may be arranged to extend from the outer surface of the first filter 610 and be caught by the second protrusion 720 of the first coupling portion 700. The upper holding portion 810 may be arranged to interfere with the second protrusion 720 of the first coupling portion 700. As the first filter 610 rotates, the upper holding portion 810 may be arranged to hold the second protrusion 720.

For example, the upper holding portion 810 may include a first extension 811 configured to cover an upper end of the second protrusion 720 of the first coupling portion 700. The first extension 811 may extend outwardly from the outer surface of the first filter 610. The extension portion 811 may extend radially outward from the outer surface of the filter body 611. The first extension 811 may be referred to as the first extension rib 811.

For example, the upper holding portion 810 may include a second extension 812 configured to cover an outer surface of the second protrusion 720 of the first coupling portion 700. The second extension 812 may extend downwardly from the first extension 811. The second extension 812 may be referred to as the second extension rib 812.

For example, the first extension 811 and the second extension 812 may be formed to have an inverted “L” shape.

The second coupling portion 800 may include the lower holding portion 820. The lower holding portion 820 may be arranged to hold the lower portion of the first coupling portion 700. The lower holding portion 820 may be arranged to be spaced downwardly from the upper holding portion 810. For example, the lower holding portion 820 may be provided at a lower end of the first filter 610.

The lower holding portion 820 may extend from the outer surface of the first filter 610 and may be coupled to the first coupling portion 700. As the first filter 610 is rotated, the lower holding portion 820 may be arranged to be held to a lower end of the first protrusion 710 of the first coupling portion 700. The lower holding portion 820 may rotate along the guide portion 740 of the first coupling portion 700. The lower holding portion 820 may be arranged to contact the stopper 730, thereby restricting rotation of the first filter 610.

The lower holding portion 820 may include a shape corresponding to the guide portion 740 of the first coupling portion 700. For example, the lower holding portion 820 may include an inclined portion 821 having a shape that slopes downward along the direction of rotation of the first filter 610. This may allow the lower holding portion 820 to rotate smoothly in the guide portion 740. In addition, as the lower holding portion 820 rotates along the guide portion 740, the coupling force between the second coupling portion 800 and the first coupling portion 700 may be increased.

The upper holding portion 810 may be referred to as the first holding portion 810. The lower holding portion 820 may be referred to as the second holding portion 820. However, the ordinal numbers of “first” and “second” do not limit the configuration. For example, they may be referred to as the second holding portion 810 and the first holding portion 820.

On the other hand, because the filter assembly 60 may be easily removed from the sump housing 100, the filter may be easily cleaned. For example, even if foreign substances are trapped in the second coupling portion 800, the first filter 610 may be easily removed from the water storage chamber 111, thereby enabling easy cleaning.

Referring to FIG. 17, the second filter 620 may include a filter portion 622 provided to filter out foreign substances contained in the water. For example, the filter portion 622 may be provided in the form of a mesh.

The filter portion 622 may filter the water that has passed through the first filter 610. For example, the filter portion 622 may be configured to filter foreign substances having a smaller size than foreign substances filtered out by the first filter 610. The filter portion 622 may filter the water that has passed through the third filter 630. For example, the filter portion 622 may be configured to filter foreign substances having a smaller size than foreign substances filtered out by the third filter 630.

The water passing through the filter portion 622 may be pumped by the circulation pump 500 and supplied to the sprayer 40. For example, the water passing through the filter portion 622 may be pumped by the circulation pump 500 and flow into the distribution chamber 121. The water flowing into the distribution chamber 121 may be selectively supplied to the plurality of spray units by the distributor (not shown). Water introduced into the plurality of spray units may be sprayed into the washing chamber C.

The second filter 620 may include a filter frame 621 provided to support the filter portion 622.

For example, the filter frame 621 may include a first frame 6211. For example, the first frame 6211 may include an annular shape.

For example, the filter frame 621 may include a second frame 6212 disposed to be spaced downwardly from the first frame 6211. For example, the second frame 6212 may include an annular shape.

For example, the filter frame 621 may include a third frame 6213. The third frame 6213 may be disposed between the first frame 6213 and the second frame 6212. For example, the third frame 6213 may be arranged to connect the first frame 6211 and the second frame 6212. For example, the third frame 6213 may include a shape extending in the vertical direction. For example, the frames 6213 may be provided in a plurality. The plurality of third frames 6213 may be arranged to be spaced apart from each other along the perimeter of the second filter 620.

Referring to FIG. 18, the third filter 630 may include a filter body 631. The filter body 631 may form an exterior of the third filter 630. The filter body 631 may be configured to filter out foreign substances contained in the water flowing in from the tub 12. For example, the filter body 631 may include a plurality of holes (not shown).

The filter body 631 may be placed on the lower surface 12b of the tub 12. For example, the filter body 631 may be seated on the tub flange 152. At least a portion of an edge 631a of the filter body 631 may be arranged to correspond to the assembly line 153. The filter body 631 may be supported by the support plate 80. At least a portion of the edge 631a of the filter body 631 may be arranged to correspond to the support portion 81 of the support plate 80.

The third filter 630 may include the filter opening 632. The filter opening 632 may be formed through the filter body 631. The first filter 610 may be inserted into the filter opening 632.

The stepped portion 633 may be formed around the filter opening 632 of the third filter 630. With the first filter 610 and the third filter 630 coupled, the filter flange 613 of the first filter 610 may be positioned above the stepped portion 633 of the third filter 630. The filter flange 613 of the first filter 610 may be seated on the stepped portion 633 of the third filter 630. The filter flange 613 may be arranged to press against the stepped portion 633 by rotating while being inserted into the filter opening 632.

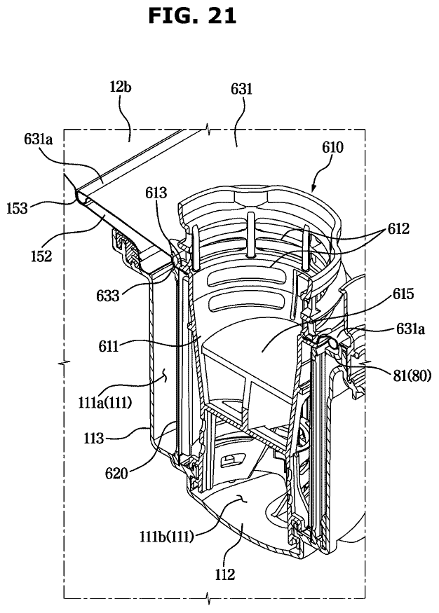

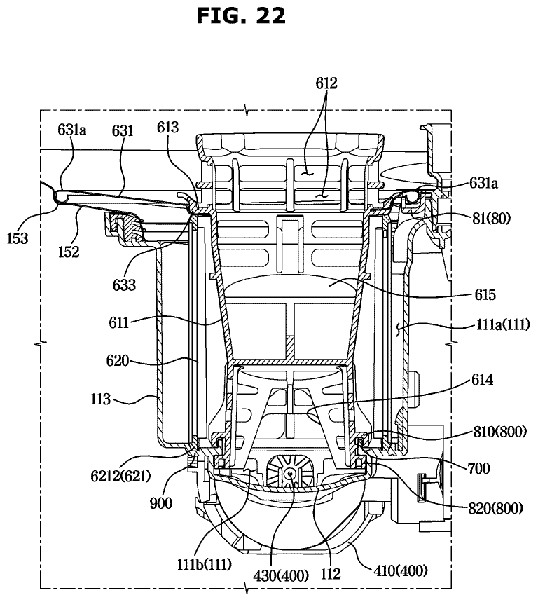

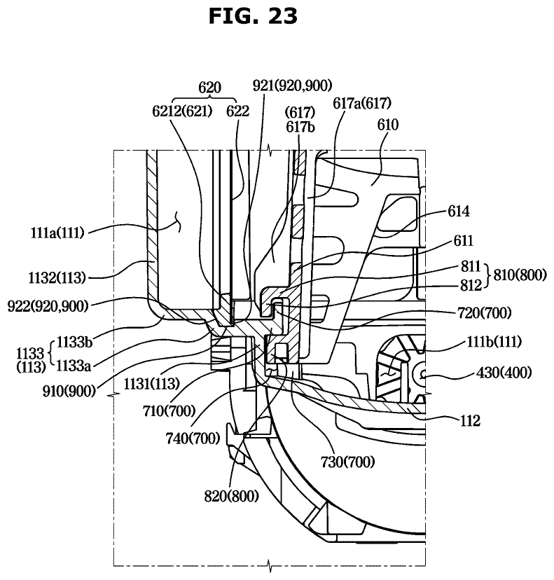

FIG. 19 is a cutaway perspective view showing a partial configuration of the dishwasher according to an embodiment. FIG. 20 is a view of the partial configuration of the dishwasher shown in FIG. 19 as viewed from a cut surface. FIG. 21 is a cutaway perspective view showing a partial configuration of the dishwasher according to an embodiment. FIG. 22 is a view of the partial configuration of the dishwasher shown in FIG. 21 as viewed from a cut surface. FIG. 23 is a partial enlarged view of the dishwasher shown in FIG. 22.

Referring to FIGS. 19 to 23, at least a portion of the filter assembly 60 may be accommodated in the water storage chamber 111. At least a portion of the filter assembly 60 may be accommodated in the washing chamber C of the tub 12.

The water storage chamber 111 may include a first region 111a in which the water filtered of foreign substances by the filter assembly 60 is provided to flow. For example, the first region 111a may be formed between the second filter 620 and the second side wall 1132. The first region 111a may be arranged to be in communication with the circulation pump 500. The water contained in the first region 111a may be pumped by the circulation pump 500 and circulated. In other words, the water contained in the first region 111a after passing through the filter assembly 60 may be circulated and sprayed back into the tub 12. The first region 111a may be referred to as the circulation chamber 111a.

The water storage chamber 111 may include a second region 111b other than the first region 111a. For example, the second region 111b may be formed on an inside of the second filter 620. For example, the second region 111b may be formed by the bottom portion 112, the first side wall 1131, and the second filter 620. The second region 111b may be provided to be in communication with the drain pump 400. The water contained in the second region 111b may be pumped by the drain pump 400 and discharged to the outside. In other words, foreign substances filtered by the filter assembly 60 and accumulated in the bottom portion 112 may be discharged together with the water. The second region 111b may be referred to as the foreign matter collecting chamber 111b.

The filter assembly 60 may be rotatably coupled to the sump housing 100. For example, the first filter 610 may be rotatable along the circumferential direction of the water storage chamber 111 within a predetermined range.

The first filter 610 may be arranged to press against the third filter 630 as it rotates. The filter flange 613 may be arranged to press against the third filter 630 by the rotational force of the first filter 610. For example, as the first filter 610 is inserted into the filter opening 632 of the third filter 630 and rotated, the filter flange 613 of the first filter 610 may be arranged to press the stepped portion 633 downward. As a result, the sealing force between the first filter 610 and the third filter 630 may be improved.

The third filter 630 pressed by the first filter 610 may be arranged to press against the tub 12. The third filter 630 pressed by the first filter 610 may be arranged to press against the lower surface 12b of the tub 12. The third filter 630 pressed by the first filter 610 may be arranged to press against the tub flange 152. The edge 631a of the third filter 630 may be arranged to press the tub flange 152 downward. For example, the edge of the third filter 630 corresponding to the assembly line 153 may be arranged to press the tub flange 152 downward. As a result, the sealing force between the third filter 630 and the tub flange 152 may be improved.

The third filter 630 pressed by the first filter 610 may be arranged to press against the support portion 81 of the support plate 80. The third filter 630 pressed by the first filter 610 may be arranged to press the support portion 81 of the support plate 80 downward. For example, the edge of the third filter 630 corresponding to the support portion 81 may be arranged to press the support portion 81 downward. As a result, the sealing force between the third filter 630 and the support plate 800 may be improved.

Through rotation of the first filter 610, the sealing force near the edge 631a of the third filter 630 may be improved. This may prevent water leakage between the third filter 630 and the tub flange 152. This may also prevent water leakage between the third filter 630 and the support plate 80. This may prevent unfiltered water from entering between the third filter 630 and the tub flange 152. This may also prevent unfiltered water from entering between the third filter 630 and the support plate 80.

The first filter 610 may be arranged to press against the second filter 620 as it rotates. The filter flange 613 may be arranged to press against the second filter 620 by the rotational force of the first filter 610. For example, as the first filter 610 is inserted into the filter opening 632 of the third filter 630 and rotated, the filter flange 613 of the first filter 610 may be arranged to press downwardly the upper portion of the second filter 620 positioned below the stepped portion 633. For example, the filter flange 613 may press down on the stepped portion 633, and the stepped portion 633 may press down on the second filter 620. As a result, the sealing force between the first filter 610 and the second filter 620 may be improved. The sealing force between the third filter 630 and the second filter 620 may be improved.

The second filter 620 pressed by the first filter 610 (or the stepped portion 633 of the third filter 630) may be arranged to press against the sump housing 100. Upon rotation of the first filter 610, the second filter 620 may be arranged to press against the seat portion 900. For example, the lower portion of the second filter 620 may be arranged to press against the scat portion 900. The second frame 6212 of the second filter 620 may be arranged to press the seating surface 910 downward. The lower surface of the second filter 620 may be arranged to be in contact with the seating surface 910. As a result, the sealing force between the second filter 620 and the seat portion 900 may be improved. In other words, through the rotation of the first filter 610, the second filter 620 and the seat portion 900 may be more effectively sealed. As a result, unfiltered water may not flow between the second filter 620 and the seat portion 900. For example, water not filtered by the second filter 620 may not flow into the first region 111a. Water from which foreign substances are not removed may remain in the second region 111b, and the foreign substances in the second region 111b may be pumped by the circulation pump 500 and not provided to the sprayer 40. As a result, recontamination of the dishware by circulation of the foreign substances may be prevented.

The seat portion 900 may hold both sides of the second filter 620. The seat portion 900 may hold the inner and outer surfaces of the second filter 620. The seat portion 900 may include a cover portion 920. The first cover protrusion 921 of the cover portion 920 may be arranged to hold the inner surface of the lower portion of the second filter 620. The second cover protrusion 922 of the cover portion 920 may be arranged to hold the outer surface of the lower portion of the second filter 620. As a result, the second filter 620 may be reliably mounted to the sump housing 100. The second filter 620 may be reliably mounted to the seating surface 910. The second filter 620 may not be easily released from the seat portion 900 by the first cover protrusion 921 and the second cover protrusion 922. The second filter 620 may not be easily shaken from the seat portion 900 by the first cover protrusion 921 and the second cover protrusion 922.

The first cover protrusion 921 and the second cover protrusion 922 may be provided with a labyrinth seal structure. In other words, the flow resistance between the first cover protrusion 921 and the second filter 620 may be increased. The flow resistance between the second cover protrusion 922 and the second filter 620 may be increased. As a result, the sealing force between the second filter 620 and the seat portion 900 may be increased. Leakage of water between the second filter 620 and the seat portion 900 may be prevented. Accordingly, unfiltered water may not flow between the second filter 620 and the seat portion 900. In other words, foreign substances in the second region 111b may not flow into the first region 111a.

With such a structure, the filter assembly 60 may be more effectively sealed with the sump housing 100. Accordingly, the water containing foreign substances may be prevented from being sprayed back toward the washing chamber C and recontamination of the dishware may be prevented. As a result, the washing performance of the dishwasher 1 may be improved.

Referring to FIG. 23, the second coupling portion 800 may be arranged to hold the first coupling portion 700 up and down. As a result, the holding force of the first coupling portion 700 and the second coupling portion 800 may be increased.

For example, the upper holding portion 810 of the second coupling portion 800 may be arranged to hold the upper portion of the first coupling portion 700. The upper holding portion 810 may be arranged to hold the second protrusion 720 of the first coupling portion 700. The upper holding portion 810 may interfere with the second protrusion 720. The upper holding portion 810 may be arranged to be coupled to the second protrusion 720.

Typically, in response to the filter being rotatably coupled to the sump housing, the filter may experience a pulling force in the vertical direction. The filter may be affected by a moment generated by the vertical pulling force. As a result, the filter may be bent inward. The filter may be deformed by long-term exposure to water at high temperature. Accordingly, the life of the filter may be limited and the filter may need to be replaced frequently. In addition, when the filter is deformed, the filter may become detached or separated from the mounting position.

In contrast, according to the present disclosure, deformation of the first filter 610 may be prevented because the second coupling portion 800 is arranged to hold the first coupling portion 700. For example, the upper holding portion 810 may be arranged to hold the second protrusion 720 in the radial direction by including the first extension 811 and the second extension 812. With such a structure, the first filter 610 may be prevented from deforming (bending) as much as possible.

For example, the lower holding portion 820 of the second coupling portion 800 may be arranged to hold the lower portion of the first coupling portion 700. As the lower holding portion 820 of the second coupling portion 800 rotates along the guide portion 740 of the first coupling portion 700, the lower holding portion 820 may be held to the lower portion of the first protrusion 710. As the rotational force of the first filter 610 increases, the holding force between the lower holding portion 820 and the first protrusion 710 may increase.

For example, as the first filter 610 rotates, the first coupling portion 700 may be arranged to press against the lower holding portion 820. For example, as the first filter 610 rotates, the first protrusion 710 may be arranged to press against the lower holding portion 820. In other words, the coupling force between the first protrusion 710 and the lower holding portion 820 may be increased by the rotational force of the first filter 610. The first protrusion 710 and the second lower holding portion 820 may be arranged to be in contact with each other. The lower surface of the first protrusion 710 and the upper surface of the second lower holding portion 820 may be arranged to be in contact.

For example, as the first filter 610 rotates, the upper holding portion 810 may press the second protrusion 720 downward. The first protrusion 710 connected to the second protrusion 720 may press the lower holding portion 820 positioned below the first protrusion 710 downward.

With such a structure, the filter assembly 60 may be more effectively held to the sump housing 100. Accordingly, the filter may not be easily deformed. The filter may not be easily detached or separated from its mounting position. In other words, the filter may be reliably held to the sump housing. In addition, the life of the filter and the time between filter replacements may be increased.

Meanwhile, the second coupling portion 800 is shown and described as being disposed in the first filter 610, but is not limited thereto. For example, the second coupling portion 800 may be disposed in the first filter 620. Based on the second filter 620 including the second coupling portion 800, the first coupling portion 700 may be formed at a position of the sump housing 100 where the second filter 620 is mounted. In other words, the coupling structure of the first coupling portion 700 and the second coupling portion 800 may also be applied to the coupling structure of the second filter 620 and the sump housing 100 corresponding to the second filter 620.

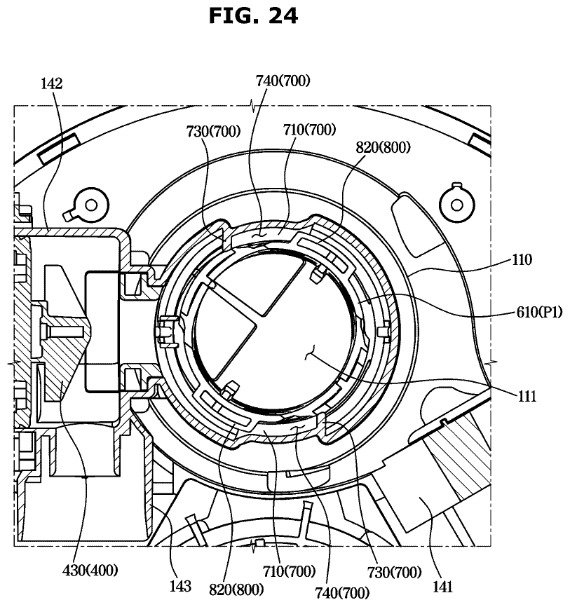

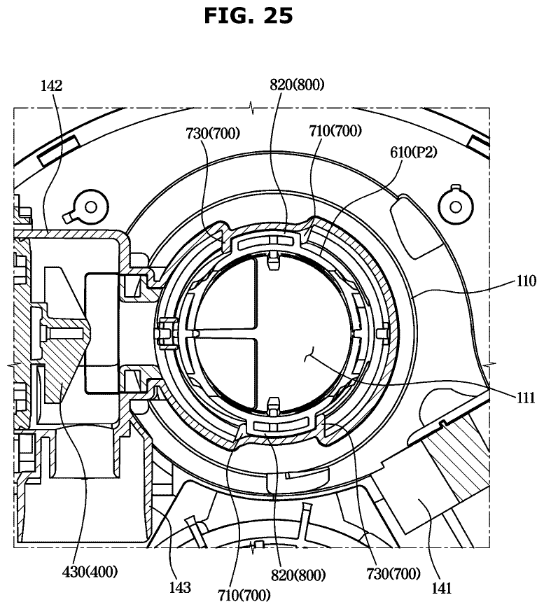

FIG. 24 is a cross-sectional view from below showing the first filter is in a first position from below. FIG. 25 is a cross-sectional view from below showing the first filter is in a second position.

Referring to FIGS. 24 and 25, the first filter 610 may be arranged to be rotatable between a first position P1 and a second position P2. The first filter 610 may be rotated in a first direction from the first position P1 to be positioned at the second position P2. The first filter 610 may be rotated in a second direction opposite to the first direction from the second position P2 to be positioned at the first position P1. For example, as the lower holding portion 820 of the second coupling portion 800 rotates along the guide portion 740 of the first coupling portion 700, the first filter 610 may move from the first position P1 to the second position P2.

Referring to FIG. 24, the first filter 610 may be positioned at the first position P1. When the first filter 610 is positioned at the first position P1, the first coupling portion 700 and the second coupling portion 800 may be in a state before being coupled (i.e., a pre-coupled state). When the first filter 610 is positioned at the first position P1, the first filter 610 may not interfere with the first protrusion 710 of the first coupling portion 700. When the first filter 610 is positioned at the first position P1, the first filter 610 may be separated from the water storage chamber 111 without any interference. For example, the lower holding portion 820 of the second coupling portion 800 may be arranged to face the first side of the guide portion 740 of the first coupling portion 700.

Referring to FIG. 25, the first filter 610 may be positioned at the second position P2. When the first filter 610 is positioned at the second position P2, the first coupling portion 700 and the second coupling portion 800 may be in a coupled state. When the first filter 610 is positioned at the second position P2, the first filter 610 may interfere with the first protrusion 710 of the first coupling portion 700. In other words, the first filter 610 may be held to the sump housing 100 and may not be separated from the water storage chamber 111. For example, the lower holding portion 820 of the second coupling portion 800 may be arranged on the second side of the guide portion 740 of the first coupling portion 700. The lower holding portion 820 of the second coupling portion 800 may be held to the lower portion of the first protrusion 710 of the first coupling portion 700. The upper holding portion 810 of the second coupling portion 800 may be arranged to be caught by the second protrusion 720 of the first coupling portion 700. When the first filter 610 is positioned at the second position P2, the second coupling portion 800 may be arranged to hold the first coupling portion 700 up and down. When the first filter 610 is positioned at the second position P2, the first protrusion 710 of the first coupling portion 700 may be arranged to press against the lower holding portion 820. As a result, the first filter 610 may be reliably locked to the sump housing 100. The first filter 610 may not be easily removed or separated from its mounting position.

While the present disclosure has been particularly described with reference to exemplary embodiments, it should be understood by those of skilled in the art that various changes in form and details may be made without departing from the spirit and scope of the present disclosure.

1. A dishwasher comprising:
a tub forming a washing chamber;
a sump including a bottom portion, a side portion, a water storage chamber formed by the bottom portion and the side portion and configured to store water in the tub, and a first coupling portion formed in the side portion; and
a filter, coupleable to and decoupleable from the water storage chamber, to filter foreign substances from the water while the filter is coupled to the water storage chamber; and
wherein the filter includes a second coupling portion coupleable to the first coupling portion by rotation so that while the second coupling portion is coupled to the first coupling portion, the second coupling portion holds the first coupling portion in place along a vertical direction of the washing chamber.

2. The dishwasher of claim 1, wherein the first coupling portion of the sump comprises:
a first protrusion protruding inwardly from the side portion, and
a second protrusion protruding upwardly from the first protrusion.

3. The dishwasher of claim 2, wherein the second coupling portion of the filter comprises an upper holding portion extending from an outer surface of the filter and configured to be caught by the second protrusion of the first coupling portion.

4. The dishwasher of claim 3, wherein the upper holding portion comprises:
a first extension extending outwardly from the outer surface of the filter to cover an upper end of the second protrusion of the first coupling portion, and
a second extension extending downwardly from the first extension to cover an outer surface of the second protrusion of the first coupling portion.

5. The dishwasher of claim 2, wherein the second coupling portion of the filter comprises a lower holding portion extending from an outer surface of the filter and configured to be held on a lower portion of the first protrusion by rotation of the filter.

6. The dishwasher of claim 5, wherein the first protrusion is configured to press against the lower holding portion by the rotation of the filter.

7. The dishwasher of claim 1, wherein
the filter is a first filter, and
the dishwasher further includes a second filter configured to surround an outer surface of the first filter, and a seat portion formed on the side portion to allow the second filter to be accommodated in the water storage chamber,
wherein the second filter is configured to press against the seat portion by rotation of the first filter.

8. The dishwasher of claim 7, wherein the seat portion further comprises:
a seating surface in contact with a lower surface of the second filter,
a first cover protrusion extending upwardly from the seating surface to cover an inner surface of the second filter, and
a second cover protrusion extending upwardly from the seating surface to cover an outer surface of the second filter.

9. The dishwasher of claim 1, wherein
the filter is a first filter,
the dishwasher further includes a second filter disposed in the water storage chamber and configured to surround an outer surface of the first filter, and a third filter located on a lower surface of the tub and disposed on an upper side of the second filter, the third filter including an opening into which the first filter is inserted,
wherein the first filter further includes a filter flange protruding from the outer surface of the first filter so as to be supported by the third filter while being inserted into the opening.

10. The dishwasher of claim 9, wherein the filter flange is configured to press against the second filter and the third filter by rotation of the first filter.

11. The dishwasher of claim 9, wherein the third filter is configured to press against the lower surface of the tub by rotation of the first filter.

12. The dishwasher of claim 1, further comprising a drain pump detachably coupled to the sump and configured to drain the water and foreign substances in the water storage chamber,
wherein the filter further includes an incision open to face the drain pump, and foreign substances filtered out by the filter flow to the drain pump through the incision.

13. The dishwasher of claim 5, wherein the first coupling portion of the sump further comprises:
a stopper interfering with the lower holding portion to limit the rotation of the filter and extending from one side of the first protrusion toward the bottom portion, and
a guide portion formed by the first protrusion and the stopper to guide movement of the lower holding portion.

14. The dishwasher of claim 13, wherein
the lower holding portion is configured to have a shape that slopes downward along a direction of rotation of the filter, and
the guide portion is configured to have a shape corresponding to the lower holding portion.

15. The dishwasher of claim 1, wherein
the filter is a first filter,
the dishwasher further includes a second filter disposed in the water storage chamber and configured to surround an outer surface of the first filter, and
the side portion of the sump comprises:
a first side wall extending upwardly from the bottom portion and couplable with the first filter,
a connecting wall extending outwardly from the first side wall and couplable with the second filter, and
a second side wall extending upwardly from the connecting wall, and the water storage chamber of the sump comprises:
a first region formed between the second filter and the second side wall to allow the water filtered of foreign substances by the first filter and the second filter to flow, and
a second region other than the first region, the second region in which foreign substances captured by the first filter and the second filter are accommodated.
